(19) United States
(12) Patent Application Publication
(10) Pub. No.: US 2008/0010967 A1
(43) Pub. Date: Jan. 17, 2008

(54) Method for Generating Energy in an Energy Generating Installation Having a Gas Turbine, and Energy Generating Installation Useful for Carrying Out the Method

(76) Inventors: Timothy Griffin, Ennetbaden (CH); Dominikus Buecker, Munich (DE); David John Abbott, Derby (GB)

Correspondence Address: CERMAK KENEALY & VAIDYA LLP, 515 E. BRADDOCK RD, SUITE B, ALEXANDRIA, VA, 22314, US

(21) Appl. No.: 11/671,515

(22) Filed: Feb. 6, 2007

Related U.S. Application Data
(63) Continuation of application No. PCT/EP05/53838, filed on Aug. 4, 2005.

(30) Foreign Application Priority Data
Aug. 11, 2004 (DE) 10 2004 039 164.5

(51) Int. Cl. F02C 3/00

(52) U.S. Cl. 60/39.182; 60/39.52; 60/775

(57) ABSTRACT

In a method for generating energy in an energy generating installation (10) having a gas turbine (12), in a first step, an oxygen-containing gas is compressed in a compressor (13, 14) of the gas turbine (12), in a second step the compressed gas is supplied, with the addition of fuel, for combustion in a combustion chamber (15), in a third step the hot flue gas from the combustion chamber (15) is expanded in a turbine (16) of the gas turbine (12) so as to perform work, and, in a fourth step, a branched-off part stream of the expanded flue gas is recirculated into a part of the gas turbine (12) lying upstream of the combustion chamber (15) and is compressed. A reduction in the CO₂ emission, along with minimal losses of efficiency, is achieved in that carbon dioxide (CO₂) is separated from the circulating gas in a CO₂ separator (19), and in that measures are taken to compensate for the efficiency losses in the gas turbine cyclic process which are associated with the CO₂ separation.

This application is a Continuation of, and claims priority under 35 U.S.C. § 120 to, International application number PCT/EP2005/053838, filed 4 Aug. 2005, and claims priority therethrough under 35 U.S.C. § 119 to German application number 10 2004 039 164.5, filed on 11 Aug. 2004, the entireties of which are incorporated by reference herein.

### BACKGROUND OF THE INVENTION

1. Field of the Invention

The present invention relates to the field of energy generating technology. It refers to a method for generating energy in an energy generating installation having a gas turbine, and to an energy generating installation useful for carrying out the method.

2. Brief Description of the Related Art

On account of their wide availability and their low price, fossil fuels are forecasted to remain the main energy source for power generation for the next 20 to 50 years. The demand for electrical energy will increase during this period at about 2-3% per year. At the same time, it is necessary to markedly reduce the CO₂ emitted by power stations, in order to stabilize the CO₂ concentration in the atmosphere.

Increased CO₂ concentrations in the atmosphere have been associated with global warming. For this reason, international agencies and local governments are at the present time deliberating on the set-up of emission systems and will possibly introduce limitations on the future CO₂ emissions of power stations. Technological options are therefore required, which allow the continuing use of fossil fuels without the high CO₂ emissions associated with them. At the same time, high efficiency and low plant costs will remain critical factors in the construction and operation of a power station.

Various projects have already been initiated, with the aim of developing low-emission processes based on gas turbines. There are three conventional ways of reducing the CO₂ emission from such power stations:

1. Methods for capturing the CO₂ on the exit side: in these methods, the CO₂ generated from the exhaust gases during combustion is removed by means of an absorption process, membranes, refrigeration processes, or combinations of these.

2. Methods for the carbon depletion of the fuel: in these methods, the fuel is converted before combustion into H₂ and CO₂, and it thus becomes possible to capture the carbon content of the fuel before entry into the gas turbine.

3. Oxygen/fuel processes (“oxy-fuel process”) with exhaust gas recirculation: in these, virtually pure oxygen is used, instead of air, as an oxidizing agent, with the result that a flue gas consisting of carbon dioxide and water is obtained.

Each of these ways, however, has disadvantages which are reflected in a reduction in efficiency, in an increase in capital costs for the power station, or in necessary conversion measures for the turbomachines.

There is, therefore, a high demand for a gas turbine cyclic process with maximum efficiency, low overall costs, and the option of the removal of CO₂.

In order to increase the efficiency of combined-cycle power stations equipped with gas turbines and to reduce costs, the following options may be envisaged:
Increasing the turbine inlet temperature.
Increasing the overall pressure ratio.
Using a gas turbine cyclic process with intermediate heating.

The first two options are linked to certain physical limits. Thus, for example, NOx emissions increase with higher combustion temperatures, and the materials of the turbine blades have their strength limits at high temperatures. On the other hand, the pressure ratio for an uncooled single-shaft compressor is limited on account of the action of the high temperature of the compressed air on the rotor materials.

### SUMMARY OF THE INVENTION

One of numerous aspects of the present invention includes providing a method for generating energy, based on a gas turbine cyclic process, and an energy generating installation useful for carrying out the method, which allow the efficient removal of carbon dioxide without appreciable losses of efficiency.

Another aspect of the present invention includes providing CO₂ separation with a partial recirculation of the flue gas and, at the same time, to take measures for compensating for the efficiency losses in the gas turbine cyclic process which are associated with the CO₂ separation.

A preferred, exemplary embodiment of the invention is distinguished in that the carbon dioxide (CO₂) is separated only partially from the circulating gas. Owing to the partial separation of the CO₂ from the recirculated and compressed flue gas, higher CO₂ concentrations, and therefore improved separation effectiveness, can be achieved.

In another preferred, exemplary embodiment, to generate the oxygen-containing gas supplied to the compressor of the gas turbine, air is enriched with oxygen. The oxygen enrichment improves the CO₂ separation. It would increase the combustion temperature if at the same time more flue gas were not recirculated or water or steam were not added.

A further preferred, exemplary embodiment of the invention is distinguished in that, before the part stream is branched off, the expanded flue gas is used for generating steam in a waste heat recovery steam generator.

In a first alternative development of the invention, the oxygen-containing gas is compressed in the compressor in at least two compressor stages connected in series, the oxygen-containing gas is intermediately cooled between the two compressor stages, the recirculated flue gas is added to the oxygen-containing gas upstream of the first compressor stage, and the carbon dioxide (CO₂) is separated from the intermediately cooled oxygen-containing gas before entry into the second compressor stage. The CO₂ separation downstream of the intermediate cooling in a multistage compressor integrates the partial CO₂ separation into a gas turbine cyclic process with high efficiency. Components derived from the aeronautics sector, which have pressure ratios of above 30 bar, typically 45 bar, may be employed. The temperatures (15° C. to 100° C., at best between 50° C. and 60° C.) which are reached after intermediate cooling are well suited to standard CO₂ separation methods, such as, for example, CO₂ membrane units.

In particular, to separate the carbon dioxide (CO₂), the oxygen-containing gas is put through a CO₂ separator, and the quantity of gas flowing through the CO₂ separator is set by means of an adjustable valve which is arranged in a bypass to the CO₂ separator. Preferably, the valve, also serving for regulation, is opened completely during the starting phase, during part-load operation, or during an emergency shutdown, in order to short-circuit the CO₂ separator.

A further improvement arises when the branched-off part stream of the flue gas is cooled in a cooler before recirculation, water optionally being extracted from the part stream. This gives rise to lower compression work in the first compressor stage and to increased water extraction. In addition, the cooler may be used in order to regulate the temperature at entry into the compressor.

A flexible type of operation is obtained in that the branched-off part stream is interrupted when the gas turbine cyclic process is to be run in a standard mode without the separation of carbon dioxide (CO₂).

It is particularly beneficial if the carbon dioxide (CO₂) is separated in the CO₂ separator in a wet method by means of membranes. In this case, the membranes are saturated with water. As a result, the cooled gas stream is saturated with water. It thereby becomes possible to integrate the CO₂ separator into plant concepts with spray cooling or with what is known as inlet fogging in the case of medium pressure upstream of the high-pressure compressor stage (for inlet fogging see, for example, the article by C. B. Meher-Homji and T. R. Mee III, Gas Turbine Power Augmentation by Fogging of Inlet Air, Proc. of 28th Turbomachinery Symposium, 1999, pages 93-113).

It is accordingly conceivable that, for intermediate cooling, water is sprayed into the stream of oxygen-containing gas, or that water is sprayed into the stream of oxygen-containing gas in the manner of inlet fogging at the inlet of the second compressor stage.

A second alternative development of the invention includes that the branched-off part stream of flue gases is compressed in a separate compressor before recirculation into the gas turbine, in particular the carbon dioxide (CO₂) being separated from the compressed part stream of flue gas, and the compressed part stream subsequently being added to the oxygen-containing gas upstream of the combustion chamber, and, to separate the carbon dioxide (CO₂), the compressed part stream is put through a CO₂ separator and the quantity of gas flowing through the CO₂ separator is set by means of an adjustable valve which is arranged in a bypass to the CO₂ separator. Furthermore, before entry into the CO₂ separator, the compressed part stream is cooled in a cooler.

It is also advantageous if the branched-off part stream of flue gas is cooled in a cooler before recirculation and water is in this case optionally extracted from the part stream, and if the flue gas expanded in the turbine of the gas turbine is intermediately heated and is expanded anew in a further turbine, and the further turbine is used for driving the separate compressor. The use of a separate compressor for the recirculated flue gas makes it possible to have a higher CO₂ concentration during CO₂ separation. Separation takes place at the full compressor pressure (at best at about 30 bar) by means of a single compressor stage. Intermediate heating affords a higher energy density in the cyclic process and reduces the NOx emissions in the process. Furthermore, the intermediate heating (by means of a second combustion chamber) allows more stable combustion in the first combustion chamber on account of the higher oxygen excess ratio in the case of a predetermined overall recirculation rate. This also results in higher flexibility in process management, such as, for example, in varying the release of heat in the first and the second combustion chamber.

A third alternative development of the invention includes that the carbon dioxide (CO₂) is separated from the flue gas expanded in the turbine of the gas turbine, and, after the separation of the carbon dioxide (CO₂), a part stream is branched off and is recirculated to the inlet of the compressor of the gas turbine, in particular the flue gas expanded in the turbine of the gas turbine being cooled in a cooler before the separation of the carbon dioxide (CO₂), and water in this case being extracted from the flue gas, and the flue gas is expanded to a few bar in the turbine of the gas turbine and the flue gas is expanded further in an exhaust gas turbine after the separation of the carbon dioxide (CO₂). The CO₂ is separated here at a low pressure, but, due to the extraction of water, a high CO₂ partial pressure is nevertheless achieved.

In a preferred embodiment of the energy generating installation according to the invention, an oxygen enrichment device preferably having air separation membranes and intended for enriching with oxygen the air sucked in by the compressor is arranged upstream of the inlet of the compressor of the gas turbine, and a waste heat recovery steam generator is arranged in the exhaust gas line.

A particularly high efficiency of the installation can be achieved when the compressor of the gas turbine includes two compressor stages, when the CO₂ separator is arranged between the two compressor stages, when an intermediate cooler is provided between the outlet of the first compressor stage and the inlet of the CO₂ separator, and when the recirculation line is returned to the inlet of the first compressor stage. The CO₂ separator is preferably bridged by means of a bypass in which an adjustable valve is arranged.

A development of this embodiment is that the recirculation line is returned to the inlet of the combustion chamber, in that a separate compressor and the CO₂ separator are arranged in series in the recirculation line, in that a cooler is provided between the separate compressor and the CO₂ separator, and in that the CO₂ separator is bridged by means of a bypass in which an adjustable valve is arranged.

### BRIEF DESCRIPTION OF THE DRAWINGS

The invention will be explained in more detail below with reference to exemplary embodiments, in conjunction with the drawing in which:

FIG. 1 shows a simplified installation diagram of an energy generating installation according to a first exemplary embodiment of the invention, with a two-stage compressor having intermediate cooling in the gas turbine;

FIG. 2 shows a simplified installation diagram of an energy generating installation according to a second exemplary embodiment of the invention, with a second gas turbine for compressing the recirculated flue gas; and

FIG. 3 shows a simplified installation diagram of an energy generating installation according to a third exemplary embodiment of the invention, in which the recirculation of the flue gas takes place after the separation of the CO₂.

### DETAILED DESCRIPTION OF EXEMPLARY EMBODIMENTS

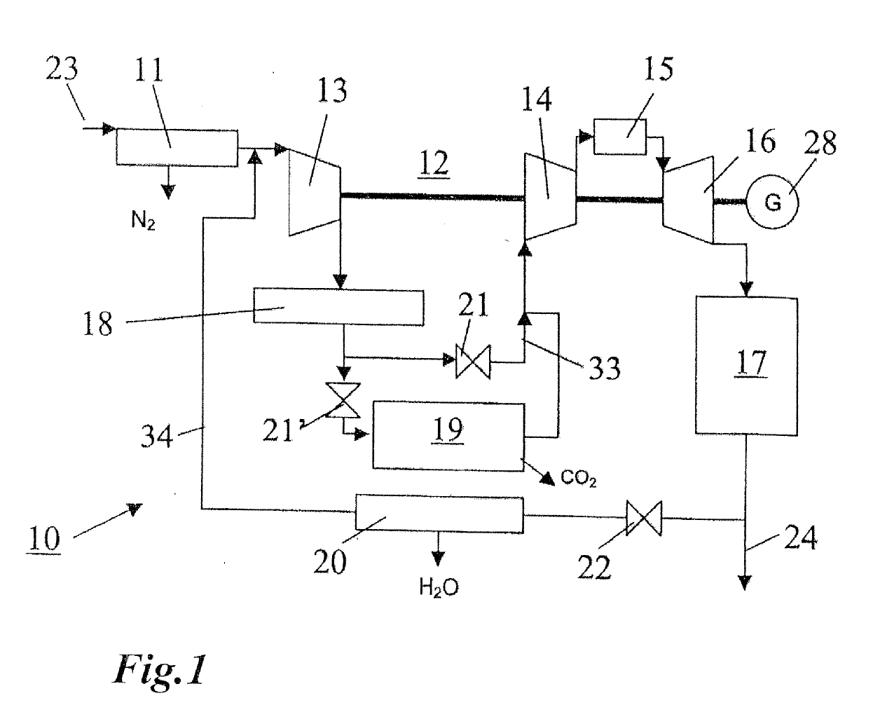

FIG. 1 reproduces a simplified installation diagram of an energy generating installation 10 according to a first exemplary embodiment of the invention. The energy generating installation 10 includes a gas turbine 12 with two compressor stages 13 and 14 connected in series, with a combustion chamber 15 and with a turbine 16 which drives a generator 28. The compressor stages 13, 14 and turbine 16 are seated on a common shaft in the usual way. Of course, the compressor stages and the turbine may also be arranged on a plurality of shafts, in which case the turbine may additionally be subdivided likewise into two or more stages. The first compressor stage 13 sucks in air 23 which, before compression, is enriched with oxygen by the extraction of nitrogen N₂ in an oxygen enrichment device 11. Flue gas recirculated from the outlet of the installation is admixed to the air, optionally enriched with oxygen. The resulting gas enriched with oxygen is precompressed in the first compressor stage 13, subsequently intermediately cooled in an intermediate cooler 18, and then supplied for postcompression to the second compressor stage 14. Before the intermediately cooled gas enters the second compressor stage 14, carbon dioxide (CO₂) is extracted from it in a CO₂ separator 19. A bypass 33 led past the CO₂ separator 19 and provided with a first adjustable valve 21 makes it possible to set the throughput through the CO₂ separator 19 and consequently the quantity of the CO₂ separated overall. A second valve 21′ arranged upstream of the CO₂ separator 19 serves both for shutting off in the event of short-circuiting by the bypass 33 and for regulation.

The gas postcompressed in the compressor stage 14 is conducted for the combustion of a fuel into the combustion chamber 15. The hot flue gas occurring during combustion is expanded in the turbine 16 so as to perform work and subsequently flows through a waste heat recovery steam generator 17 where it generates steam for a steam turbine or other purposes. After leaving the waste heat recovery steam generator 17, the flue gas is discharged via an exhaust gas line 24. Branching off from the exhaust gas line 24, part of the flue gas is recirculated to the inlet of the first compressor stage 13 via a recirculation line 34 and, as already described above, is admixed to the air (optionally) enriched with oxygen. A valve 22 and a cooler 20 are arranged in the recirculation line 34. With the aid of the valve 22, the recirculation rate can be set or recirculation can be interrupted completely. The cooler 20 reduces the compression work by cooling the flue gas. It may, furthermore, extract water from the recirculated flue gas.

An advantageous aspect of the gas turbine cyclic process illustrated in FIG. 1 is the combination of flue gas recirculation with partial separation of CO₂ and of a highly efficient turbine cyclic process with multistage compression and intermediate cooling. The air quantity required for stoichiometric combustion (with λ=1) determines the maximum recirculation ratio for the flue gas. A higher recirculation ratio is advantageous because it maximizes the CO₂ concentration in the gas flowing through the intermediate cooler 18 and the CO₂ separator 19. The enrichment of the intake air with oxygen, which can be achieved within the oxygen enrichment device 11, for example, using air separation membranes operating at low temperatures, makes it possible, with a predetermined combustion temperature of the gas turbine 12, to have a higher recirculation of the flue gas.

The installation illustrated in FIG. 1 has the following properties and advantages:
Due to the partial separation of the CO₂ from the recirculated and precompressed flue gas, higher CO₂ concentrations, and therefore higher efficiencies in CO₂ separation, can be achieved by the CO₂ separator 19.
By the valve 21, it is possible to set optimally the fraction of the gas passing through the CO₂ separator 19. During the starting phase, in part-load operation or during a rapid shutdown, the valve 21 can be opened fully in order to short-circuit the CO₂ separator 19.
The valve 22 in the recirculation line 34 can be used, during faults, in part-load operation or in the starting phase, for running the process in the standard mode without CO₂ separation.
The arrangement of the CO₂ separator 19 downstream of the intermediate cooler 18 of a multistage compressor 13, 14 integrates CO₂ separation into a gas turbine cyclic process with high efficiency. Components originating from aeronautics and having pressure ratios above 30 bar, typically at 45 bar, may be used. The temperatures (20° C. to 100° C., in particular between 50° C. and 60° C.) reached at the outlet of the intermediate cooler 18 are adapted to those of the standard CO₂ separation process, such as, for example, in a CO₂ membrane unit.
Specific CO₂ membrane units are usually operated in a wet mode (saturated with water). Consequently, the membranes saturate the cooled gas stream with water. The CO₂ separator 19 can thus be integrated into concepts with intermediate spray cooling or with inlet fogging in the case of medium pressures upstream of the postcompressor stage.
Optional enrichment with oxygen allows an increased recirculation of the flue gas (note: the enriched O₂ increases the combustion temperature if the diluting constituent is not at the same time increased, which may take place either by increased flue gas recirculation or by the addition of water or steam).
The cooler or condenser 20 in the recirculation line 34 allows an increased recovery of water at the expense of greater cooling.

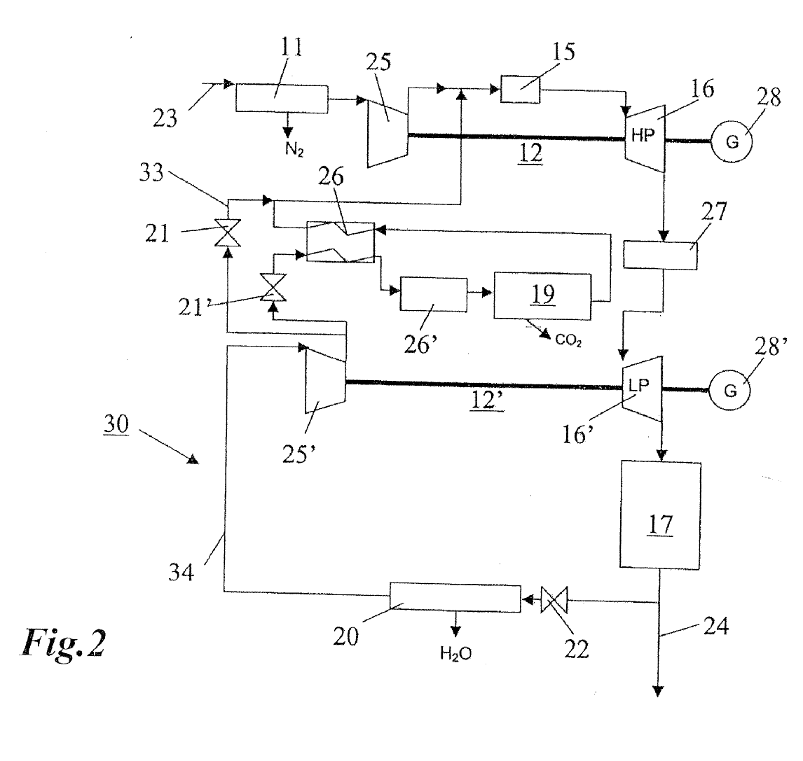

The installation diagram of the exemplary embodiment shown in FIG. 2 includes two gas turbines 12 and 12′ in an energy generating installation 30. The first gas turbine 12 includes a compressor 25, a combustion chamber 15, and a turbine 16 which drives a first generator 28. Here, too, air 23 sucked in the gas turbine 12 is (optionally) enriched with oxygen in an oxygen enrichment device 11, compressed in the compressor 25, and used for the combustion of fuel in the combustion chamber 15. The hot flue gases are expanded first in the turbine 16 of the first gas turbine 12 and subsequently in the turbine 16′ of the second gas turbine 12′. Additional heating in an intermediate heater 27 (sequential combustion) may optionally be carried out between the two turbines 16 and 16′. The expanded flue gas is subsequently conducted through a waste heat recovery steam generator 17 and discharged in an exhaust gas line 24. Part of the flue gas is recirculated again and admixed, directly upstream of the combustion chamber 15, to the oxygen-enriched and compressed air. The necessary compression takes place in the compressor 25′ of the second gas turbine 12′, which may at the same time drive a second generator 28′. In a similar way to FIG. 1, after compression, the recirculated flue gas is cooled in a cooler 26′ and is subsequently partially freed of the carbon dioxide in a CO₂ separator 19. To set the separation rate, hereto, a bypass 33 with a valve 21 may be provided. To regulate and shut off the stream through the CO₂ separator 19, once again a second valve 21′ can be used upstream of the CO₂ separator 19. Upstream of the cooler 26′, a regenerative heat exchanger 26 may additionally be arranged, in which the CO₂-depleted gas leaving the CO₂ separator 19 is preheated, before combustion, in a thermo dynamically efficient way and a large part of the cooling power of the heat exchanger 26 is thus recovered. The valve 22 and the cooler 20 in the recirculation line 34 fulfill the same functions as in FIG. 1. The bypass 33 should necessarily bridge the CO₂ separator 19 and the two coolers 26 and 26′, since otherwise cooling takes place upstream of the combustion chamber 15, this being unfavorable in thermo dynamic terms.

The separate compressor 25′ makes it possible to have a higher CO₂ concentration and therefore an increase in the effectiveness of CO₂ separation. At the same time, the efficiency of the process rises due to the intermediate heating. The installation illustrated in FIG. 2 has, correspondingly, the following properties and advantages:
CO₂ separation takes place at full compressor pressure (optimally about 30 bar) by a single compressor stage on account of the separate compressor.
the use of intermediate heating gives higher energy density in the process.
the use of intermediate heating reduces the NOx emission in the process.
the use of intermediate heating makes it possible, because of the higher oxygen excess ratio, in the case of a predetermined overall recirculation rate, to have more stable combustion in the first burner (combustion chamber 15). This affords higher flexibility in the control of the process, that is to say, a greater range of variation in the heat release in the first and the second burner (intermediate heater 27).

Moreover, the compressors and turbines may also be connected to one another in a way different from FIG. 2, in order to make it possible to use a power turbine running freely (on a separate shaft). Furthermore, it is also conceivable to provide multistage compression with intermediate cooling of the recirculated flue gas. In this case, CO₂ separation would take place at a lower pressure, but a higher system pressure overall could be achieved. The bypass would then include only the CO₂ absorber unit, but not the coolers which, moreover, would not be designed regeneratively.

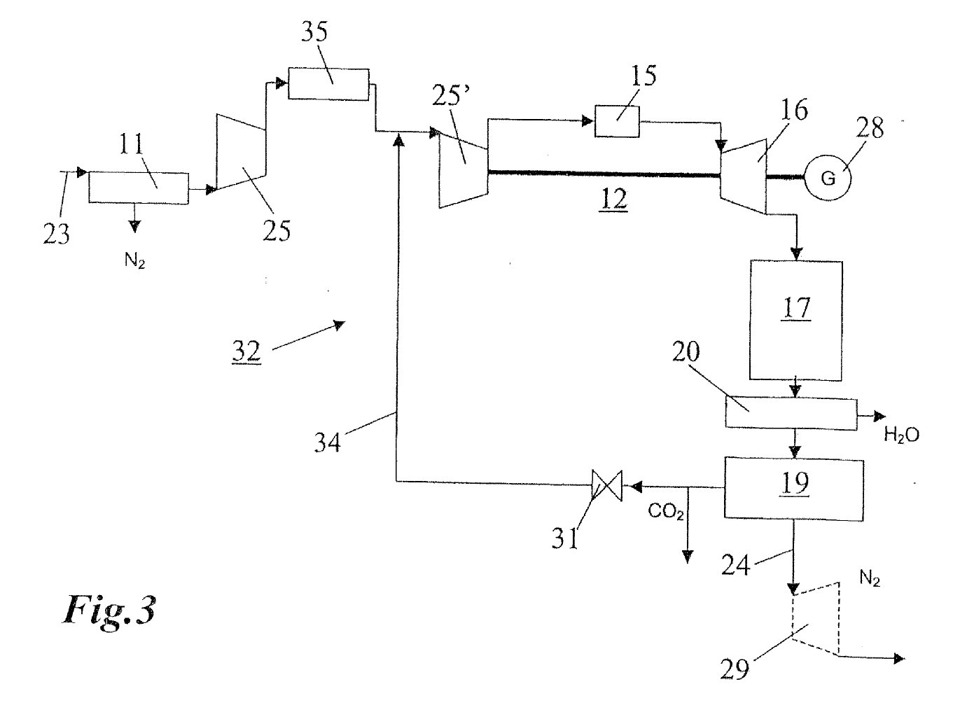

The installation diagram of the exemplary embodiment shown in FIG. 3 includes an energy generating installation 32 with a gas turbine 12 having a compressor 25′, combustion chamber 15, and turbine 16 and following waste heat recovery steam generator 17. After running through the waste heat recovery steam generator 17, the flue gas is dewatered in a cooler 20 and subsequently freed partially from carbon dioxide in the CO₂ separator 19. Only after CO₂ separation is part of the flue gas recirculated to the inlet of the compressor 25′ via the recirculation line 34 and mixed with the oxygen-enriched intake air 23. The rest of the flue gas can be expanded further in an optional following exhaust gas turbine 29. In addition, the air 23 present at the inlet and enriched with oxygen in the oxygen enrichment device 11 may be precompressed in a compressor 25 and optionally cooled intermediately in an intermediate cooler 35. Thus, for example, a pressure ratio of 10 in the precompression (compressor 25) of the oxygen-containing gas and a pressure ratio of 10-20 in the main compression (25′) could be selected. If highly enriched air is then used, an efficient process can thus be achieved.

In this version, the carbon dioxide is separated before recirculation. Although the CO₂ is separated at a lower pressure, the dewatering results in a high CO₂ partial pressure. The installation illustrated in FIG. 3 has, correspondingly, the following properties and advantages:
in contrast to FIG. 1 and 2, the flue gas is subjected overall to CO₂ separation. Part of the flue gas is then recirculated. However, this procedure may also be employed in concepts with intermediate cooling (similar to FIG. 1) and intermediate heating (similar to FIG. 2).
water may be injected (not illustrated in FIG. 3), in order to reduce the NOx emissions of the combustion and to reduce the degree of flue gas recirculation required for a predetermined CO₂ exhaust gas concentration.

Other possibilities arise when a cyclic process with a high degree of water injection (intermediate spray cooling, water or steam injection into the combustion chamber) is combined with the model of partial flue gas recirculation:
when the high fraction of water in the flue gas is removed, the CO₂ concentration rises. As a result, the efficiency of CO₂ separation is improved, specifically both in the “tail-end” configuration according to FIG. 3, that is say in a solution with following CO₂ separation at the end of the process, and in separation in the medium-pressure range according to FIGS. 1 and 2.
the addition of water makes it possible to have the same combustion temperature with less flue gas recirculation. This may have effects on efficiency in cases where the water supply is uncritical.
water injection may also be employed in processes without flue gas recirculation, in order to allow efficient “tail-end” CO₂ separation after water condensation. In a limit situation, sufficient water could be added to the process to allow combustion with X near to 1 at reasonable temperatures without flue gas recirculation.

### LIST OF REFERENCE SYMBOLS

10, 30, 32 energy generating installation
11 oxygen enrichment device
12, 12′ gas turbine
13, 14 compressor stage
15 combustion chamber
16, 16′ turbine
17 waste heat recovery steam generator (HRSG)
18, 35 intermediate cooler
19 CO₂ separator
20, 26′ cooler
21, 21′, 22, 31 valve
23 air
24 exhaust gas line
25, 25′ compressor
26 regenerative heat exchanger
27 intermediate heater
28, 28′ generator
29 exhaust gas turbine
33 bypass
34 recirculation line

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for generating energy in an energy generating installation having a gas turbine, the method comprising:
compressing an oxygen-containing gas in a compressor of the gas turbine;
thereafter supplying the compressed, with fuel, for combustion in a combustion chamber, to generate hot flue gas;
thereafter expanding the hot flue gas from the combustion chamber in a turbine of the gas turbine to perform work, to generate expanded flue gas;
thereafter recirculating a branched-off part stream of the expanded flue gas into a part of the gas turbine upstream of the combustion chamber, and compressing said recirculated expanded flue gas;
separating carbon dioxide from the circulating gas in a CO₂ separator; and
compensating for efficiency losses in the gas turbine cyclic process associated with the CO₂separating.

2. The method as claimed in claim 1, wherein separating carbon dioxide is only partially separating carbon dioxide from the circulating gas.

3. The method as claimed in claim 1, further comprising:
before said compressing, enriching air with oxygen to generate the oxygen-containing gas compressed in the compressor of the gas turbine.

4. The method as claimed in claim 3, wherein said enriching air with oxygen is performed in an oxygen enrichment device including operating air separation membranes at low temperatures.

5. The method as claimed in claim 1, further comprising, between said expanding and said recirculating, generating steam with the expanded flue gas in a waste heat recovery steam generator.

6. The method as claimed in claim 1, wherein compressing the oxygen-containing gas comprises compressing in the compressor in at least two compressor stages connected in series, and further comprising intermediately cooling the oxygen-containing gas between compressing in the at least two compressor stages.

7. The method as claimed in claim 6, comprising:
adding the recirculated flue gas to the oxygen-containing gas upstream of the first compressor stage and
separating the carbon dioxide from the intermediately cooled oxygen-containing gas before entry into the second compressor stage.

8. The method as claimed in claim 7, wherein separating the carbon dioxide comprises passing the oxygen-containing gas through a CO₂ separator, setting the quantity of gas flowing through the CO₂ separator by a first adjustable valve arranged in a bypass to the CO₂ separator, and regulating the stream conducted through the CO₂ separator by a second valve arranged upstream of the CO₂ separator.

9. The method as claimed in claim 8, comprising:
opening the first adjustable valve in the bypass completely during a starting phase, during part-load operation, or during an emergency shutdown, to short-circuit the CO₂ separator.

10. The method as claimed in claim 7, further comprising:
cooling the branched-off part stream of the flue gas in a cooler before said recirculating, optionally extracting water from the part stream.

11. The method as claimed in claim 7, further comprising:
interrupting the branched-off part stream when the gas turbine cyclic process is to be run in a standard mode without the separation of carbon dioxide.

12. The method as claimed in claim 7, wherein separating the carbon dioxide comprises separating in the CO₂ separator in a wet method with membranes.

13. The method as claimed in claim 7, wherein intermediate cooling comprises spraying water into the stream of oxygen-containing gas.

14. The method as claimed in claim 7, further comprising:
inlet fogging with water into the stream of oxygen-containing gas at the inlet of the second compressor stage.

15. The method as claimed in claim 1, comprising:
compressing the branched-off part stream of flue gases in a separate compressor before said recirculating into the gas turbine.

16. The method as claimed in claim 15, comprising:
compressing the carbon dioxide from the compressed part stream of flue gas; and
thereafter adding the compressed part stream to the oxygen-containing gas upstream of the combustion chamber.

17. The method as claimed in claim 16, wherein separating the carbon dioxide (CO₂)comprises:
passing the compressed part stream through a CO₂ separator;
setting the quantity of gas flowing through the CO₂ separator by a first adjustable valve arranged in a bypass to the CO₂ separator; and
regulating the stream conducted through the CO₂ separator with a second valve arranged upstream of the CO₂ separator.

18. The method as claimed in claim 17, comprising:
cooling the compressed part stream in a cooler before entry into the CO₂ separator;
precooling the compressed part stream in a regenerative heat exchanger before entry into the cooler; and
preheating the compressed part stream after leaving the CO₂ separator in the regenerative heat exchanger.

19. The method as claimed in claim 15, comprising:
cooling the branched-off part stream of flue gas in a cooler before said recirculating, and optionally extracting water from the branched-off part stream.

20. The method as claimed in claim 15, comprising:
intermediately heating the flue gas expanded in the turbine of the gas turbine expanding the intermediately heated flue gas in a second turbine; and
driving the separate compressor with the second turbine.

21. The method as claimed in claim 1, comprising:
separating the carbon dioxide (CO₂) from the flue gas expanded in the turbine of the gas turbine; and
thereafter, branching off a part stream and recirculating said part stream to the inlet of the compressor of the gas turbine.

22. The method as claimed in claim 21, comprising:
cooling the flue gas expanded in the turbine of the gas turbine in a cooler before said separating of the carbon dioxide (CO₂), and optionally extracting water from the flue gas.

23. The method as claimed in claim 21, wherein expanding the flue gas comprises expanding to a few bar in the turbine of the gas turbine, and comprising further expanding the flue gas in an exhaust gas turbine after said separating of the carbon dioxide (CO₂).

24. The method as claimed in claim 21, further comprising:
precompresssing the oxygen-containing gas in a second compressor before said compressing in the gas turbine, and thereafter intermediately cooling the oxygen-containing gas in an intermediate cooler.

25. An energy generating installation useful for carrying out the method as claimed in claim 1, comprising:
a gas turbine with a compressor having an outlet, a turbine having an inlet and an outlet, and a combustion chamber arranged between the compressor outlet and the turbine inlet, and an exhaust gas line connected to the turbine outlet of the turbine;
a recirculation line branching off from the exhaust gas line, configured and arranged to recirculate gas into a part of the gas turbine upstream of the combustion chamber;
a CO₂ separator arranged within a gas circuit formed by the recirculation line; and
means for compensating for efficiency losses in the gas turbine cyclic process associated with CO₂ separation.

26. The energy generating installation as claimed in claim 25, further comprising:
an oxygen enrichment device configured and arranged to enrich with oxygen the air sucked in by the compressor, arranged upstream of the inlet of the compressor of the gas turbine.

27. The energy generating installation as claimed in claim 25, further comprising:
a waste heat recovery steam generator arranged in the exhaust gas line.

28. The energy generating installation as claimed in claim 25, wherein the compressor of the gas turbine comprises two compressor stages, wherein the CO₂ separator is arranged between the two compressor stages, further comprising an intermediate cooler between an outlet of the first compressor stage and an inlet of the CO₂ separator, and wherein the recirculation line is connected to the inlet of the first compressor stage.

29. The energy generating installation as claimed in claim 28, further comprising:
a bypass including a first adjustable valve bridging the CO₂ separator; and
a second valve configured and arranged to regulate the stream conducted through the CO₂ separator, arranged upstream of the CO₂ separator.

30. The energy generating installation as claimed in claim 25, wherein the recirculation line returns to the inlet of the combustion chamber, and further comprising a separate compressor arranged in series with the CO₂ separator in the recirculation line.

31. The energy generating installation as claimed in claim 30, further comprising:
a cooler between the separate compressor and the CO₂ separator; and
a regenerative heat exchanger arranged upstream of the cooler through which recirculated gas flows to the cooler and gas emerging from the CO₂ separator flows to the combustion chamber.

32. The energy generating installation as claimed in claim 30, further comprising:
a bypass bridging the CO₂ separator, the bypass including a first adjustable valve; and
a second valve configured and arranged for regulating the stream conducted through the CO₂ separator, arranged upstream of the CO₂ separator.

33. The energy generating installation as claimed in claim 30, further comprising:
an intermediate heater and a second turbine arranged in series in the exhaust gas line.

34. The energy generating installation as claimed in claim 25, further comprising a valve arranged in the recirculation line.

35. The energy generating installation as claimed in claim 25, further comprising:
a cooler arranged in the recirculation line.

36. The energy generating installation as claimed in claim 25, wherein the CO₂ separator is arranged in the exhaust gas line, wherein the recirculation line is returned from an outlet of the CO₂ separator to an inlet of the compressor of the gas turbine, and further comprising a valve in the recirculation line.

37. The energy generating installation as claimed in claim 36, further comprising:
a cooler arranged upstream of the inlet of the CO₂ separator; and
an exhaust gas turbine in the exhaust gas line at the outlet of the CO₂ separator.

38. The energy generating installation as claimed in claim 36, further comprising:
a second compressor with a following intermediate cooler arranged upstream of the inlet of the compressor of the gas turbine.

39. The energy generating installation as claimed in claim 26, wherein the oxygen enrichment device comprises air separation membranes.
